(19) United States
(12) Patent Application Publication
(10) Pub. No.: US 2011/0050754 A1
(43) Pub. Date: Mar. 3, 2011

(54) DISPLAY DEVICE AND DRIVING METHOD THEREOF

(75) Inventor: Chang-Ho Hyun, Yongin-City (KR)

(73) Assignee: SAMSUNG MOBILE DISPLAY CO., LTD., YONGIN-CITY (KR)

(21) Appl. No.: 12/869,961

(22) Filed: Aug. 27, 2010

(30) Foreign Application Priority Data
Aug. 27, 2009 (KR) 10-2009-0080041

(51) Int. Cl. G09G 5/10

(52) U.S. Cl. 345/690

(57) ABSTRACT

A display device and a driving method thereof that can prevent distortion of luminance characteristics upon application of an ACL algorithm are disclosed. The display device includes a signal controller configured to correct luminance data according to the difference between image data of a current frame and image data of a previous frame.

### CROSS-REFERENCE TO RELATED APPLICATIONS

This application claims priority to and the benefit of Korean Patent Application No. 10-2009-0080041 filed in the Korean Intellectual Property Office on Aug. 27, 2009, the entire contents of which are incorporated herein by reference.

### BACKGROUND

1. Field

The field relates to a display device and a driving method thereof. More particularly, the field relates to an organic electroluminescence display device and a driving method thereof.

2. Description of the Related Technology

A display device includes a plurality of pixels arranged on a substrate in a matrix to form a display region. Scan lines and data lines are coupled to each pixel for selectively applying data signals to the pixels in order to display images. Display devices are classified as either passive matrix or active matrix depending on driving systems for the pixels. The active matrix type of light emitting display device, which selectively turns on light in every unit pixel, has mainly been used because of better resolution, contrast, and operation speed.

Such a display device has been used as a display device for a portable information terminal such as a personal computer, a mobile telephone, a PDA, etc., or as a monitor for various information equipment. An LCD using a liquid crystal panel, an organic electroluminescence display device using organic light emitting elements, and a PDP using a plasma panel, etc., have been known. Various light emitting display devices with low weight and volume compared with cathode ray tubes have been developed. In particular, an organic electroluminescence display device that has excellent luminous efficiency, luminance, viewing angle, and a rapid response time has been preferred.

In the organic electroluminescence device, the luminance of the entire screen may be reduced using an automatic current limit (ACL) algorithm, in which current is controlled when the entire screen is lit with a high luminance by an image signal for a frame. Particularly, if an ACL algorithm is applied in a structure with no frame memory, a correction value that is determined in the current frame is applied to the next frame. In the case of a data signal of the next frame that is corrected according to the correction value of the previous frame, an image of the next frame is affected by remaining parts of the data signal written in each pixel during the previous frame. That is, image data of the next frame is corrected by a different correction value than the correction value calculated in the next frame. Because of this, there is a problem that the luminance characteristics may be adversely affected by applying the ACL algorithm.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE EMBODIMENTS

One aspect is a display device including a signal controller configured to generate luminance data in response to a control signal, where the signal controller includes a luminance corrector that corrects the luminance data of a current frame according to a correction value which depends on a difference in luminance data between a previous frame and a current frame, and a display unit configured to display an image in response to the corrected luminance data.

Another aspect is a method of driving a display device, the method including summing luminance data of a previous frame, summing luminance data of a current frame, comparing the summed luminance data of the previous frame with the summed luminance data of the current frame, calculating a correction value depending on a result of the comparison, and correcting the luminance data of the current frame based on the correction value.

### BRIEF DESCRIPTION OF THE DRAWINGS

FIG. 1 is a block diagram showing a display device according to an exemplary embodiment of the present invention.

FIG. 2 is an equivalent circuit diagram of a pixel PX of FIG. 1.

FIG. 3 is a block diagram of a luminance corrector of FIG. 1.

FIGS. 4 and 5 are views for explaining a driving method of a display device according to an exemplary embodiment of the present invention.

### DETAILED DESCRIPTION OF CERTAIN INVENTIVE EMBODIMENTS

In the following detailed description, only certain exemplary embodiments are shown and described, simply by way of illustration. As those skilled in the art realize, the described embodiments may be modified in various different ways, without departing from the spirit or scope of the present invention. Accordingly, the drawings and description are to be regarded as illustrative in nature and not restrictive. Like reference numerals generally designate like elements throughout the specification.

Throughout this specification and the claims that follow, when it is described that an element is “coupled” to another element, the element may be “directly coupled” to the other element or “indirectly coupled” to the other element through a third element.

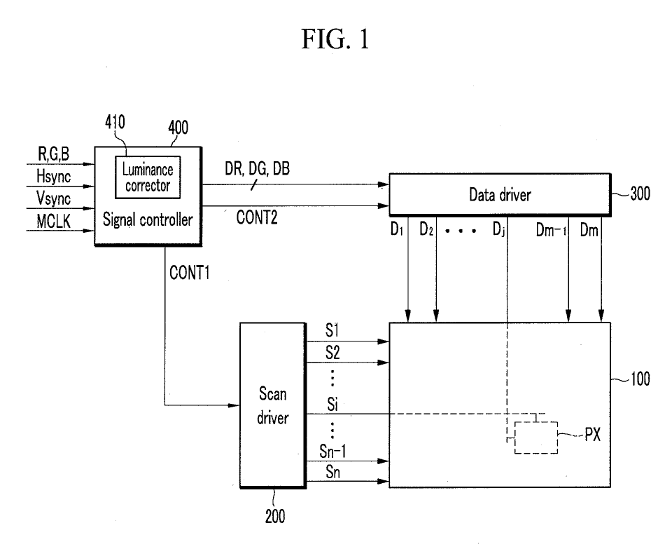

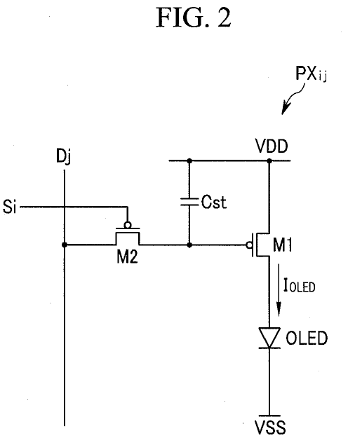

FIG. 1 is a block diagram showing a display device according to an exemplary embodiment, and FIG. 2 is an equivalent circuit diagram of a pixel PX of FIG. 1.

Referring to FIG. 1, the display device includes a display unit 100, a scan driver 200, a data driver 300, and a signal controller 400. The display unit 100, as seen from FIG. 1, includes a plurality of signal lines S1-Sn and D1-Dm and a plurality of pixels PX connected to the signal lines S1-Sn and D1-Dm and substantially arranged in a matrix. The signal lines S1-Sn and D1-Dm include a plurality of scan lines S1-Sn for transmitting scan signals and a plurality of data lines D1-Dm for transmitting data voltages. The scan signal lines S1-Sn extend substantially in a row direction and are substantially parallel to each other, while the data lines D1-Dm extend substantially in a column direction and are substantially parallel to each other.

Referring to FIG. 2, each pixel, for example a pixel PXij connected to an i-th (i=1, 2, . . . , n) scan line Si and a j-th (j=1, 2, . . . , m) data line Dj, includes an organic light emitting diode OLED, a driving transistor M1, a capacitor Cst, and a switching transistor M2. A source terminal of the driving transistor M1 receives a first driving voltage VDD, and a drain terminal thereof is connected to an anode terminal of the organic light emitting diode OLED. A gate terminal of the driving transistor M1 is connected to a drain terminal of the switching transistor M2. The driving transistor M1 sources a current I_{OLED}, which varies according to a voltage applied between the gate terminal and the drain terminal. The current I_{OLED} flows to the organic light emitting diode OLED. A gate terminal of the switching transistor M2 is connected to the scan line Si, and a source terminal thereof is connected to the data line Dj. The switching transistor M2 performs a switching operation in response to a scan signal applied to the scan line Si, and when the switching transistor M2 is turned on, a data signal applied to the data line Dj, i.e., a data voltage, is transmitted to the gate terminal of the driving transistor M1.

The capacitor Cst is connected between the source terminal and gate terminal of the driving transistor M1. The capacitor Cst charges a data voltage applied to the gate terminal of the driving transistor, and maintains the data voltage at the gate terminal of the driving transistor after the switching transistor M2 is turned off.

A cathode terminal of the organic light emitting diode (OLED) receives a second driving voltage VSS. The organic light emitting diode (OLED) emits light with an intensity depending on the current I_{OLED} supplied from the driving transistor M1. The organic light emitting diode OLED can emit light of one of a plurality of colors. Examples of the colors may include the three colors red, green, and blue. The three colors are spatially and temporally synthesized, and thus a desired color is recognized. In some embodiments, the organic light emitting diodes OLEDs emit white light, and therefore luminance increases. Alternatively, in some embodiments, the organic light emitting diodes OLEDs of all pixels PX emit white light, and some pixels PX may further include color filters (not shown) for converting the white light emitted from the organic light emitting diodes OLED into light of one of the colors.

Although FIG. 2 illustrates the driving transistor M1 and the switching transistor M2 as being p-channel field effect transistors FETs, the present invention is not limited thereto, and at least one of the driving transistor M1 and the switching transistor M2 may be an n-channel field effect transistor. Also, the relationship of connection among the driving transistor M1, the switching transistor M2, the capacitor Cst, and the organic light emitting diode (OLED) may be varied. The pixel PX shown in FIG. 2 is one example of one pixel of the display device, and a pixel of a different type may be used.

Referring again to FIG. 1, the scan driver 200 is connected to the scan lines S1-Sn of the display unit 100, and sequentially applies scan signals to the scan lines S1-Sn in response to a scan control signal CONT 1. Each scan signal is a combination of a gate-on voltage Von for turning on the switching transistor M2 and a gate-off voltage Voff for turning off the switching transistor M2. If the switching transistor M2 is a p-channel field effect transistor, the gate-on voltage Von and the gate-off voltage Voff are a low voltage and a high voltage, respectively.

The data driver 300 is connected to the data lines D1-Dm, and converts image data DR, DG, and DB input from the signal controller 400 into a data voltage in response to a data control signal CONT2 and applies the data to the data lines D1-Dm.

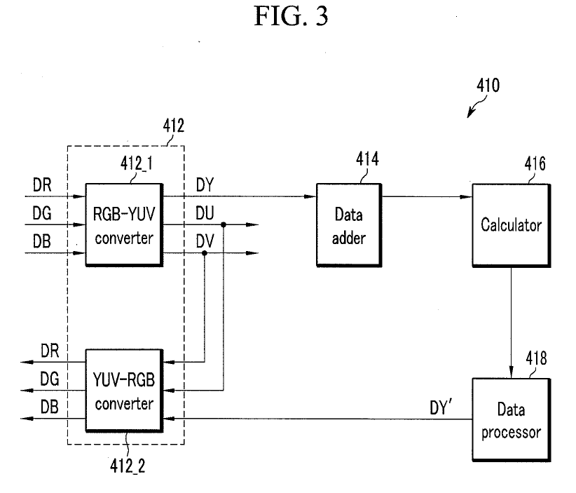

The signal controller 400 receives input signals R, G, and B, a horizontal synchronization signal Hsync, a vertical synchronization signal Vsync, and a main clock signal MCLK, and generates image data DR, DG, and DB. The signal controller 400 includes a luminance corrector 410 for correcting the image data DR, DG, and DB with a correction value depending on a result of comparison of the total data values of the image data DR, DG, and DB between the previous frame and the current frame. An embodiment of the luminance corrector 410 is described below with reference to FIG. 3.

The signal controller 400 also generates a scan control signal CONT1 and a data control signal CONT2. The scan control signal CONT1 includes a scan start signal STV for instructing the scan driver 200 to start scanning and at least one clock signal for controlling the output period of the gate-on voltage Von. The scan control signals CONT1 may further include an output enable signal OE for defining the duration of the gate-on voltage Von. The data control signals CONT2 include a horizontal synchronization start signal STH for informing of start of transmission of image data DR, DG, and DB for a row of pixels PX to the data driver 300 and a load signal LOAD for instructing to apply data voltages to the data lines D1-Dm.

FIG. 3 is a block diagram of an embodiment of the luminance corrector 410 of FIG. 1.

Referring to FIG. 3, the luminance corrector 410 includes a data converter 412, a data adder 414, a calculator 416, and a data processor 418. The data converter 412 includes an RGB-YUV converter 412_1 and a YUV-RGB converter 412_2. The RGB-YUV converter 412_1 converts image data DR, DG, and DB into luminance data DY and chrominance data DU and DV. Conversion between the image data DR, DG, and DB and the luminance data DY and chrominance data DU and DV can take many different formats depending on the standards used. For instance, the following Equation 1 can be used.

$$( \begin{matrix}Y \\ U \\ V\end{matrix} ) = ( \begin{matrix}0.299 & 0.587 & 0.114 \\ - 0.147 & - 0.289 & 0.436 \\ 0.615 & - 0.515 & - 0.100\end{matrix} ) ( \begin{matrix}R \\ G \\ B\end{matrix} ) \qquad ( Equation 1 )$$

The YUV-RGB converter 412_2 converts luminance data DY′ and chrominance data DU and DV into image data DR, DG, and DB. Conversion between the luminance data DY′ and chrominance data DU and DV and the image data DR, DG, and DB can take many different formats depending on the standards used. For instance, the following Equation 2 can be used.

$$( \begin{matrix}R \\ G \\ B\end{matrix} ) = ( \begin{matrix}1.000 & 0.000 & 1.140 \\ 1.000 & - 0.395 & - 0.581 \\ 1.000 & 2.032 & 0.000\end{matrix} ) ( \begin{matrix}Y \\ U \\ V\end{matrix} ) \qquad ( Equation 2 )$$

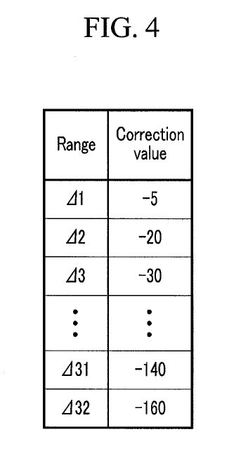

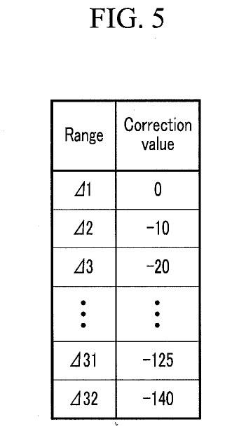

The data adder 414 sums at least a portion, or all, or substantially all of the luminance data DY for one frame. The calculator 416 compares total luminance data DYn-1 of an (n−1)-th frame and total luminance data DYn of an n-th frame, and calculates a correction value of the luminance data DYn of the n-th frame according to the comparison result. The calculator 416 calculates a correction value by using first and second lookup tables. A concrete description of the first and second lookup tables will be given with reference to FIGS. 4 and 5. The data processor 418 applies the correction value calculated by the calculator 416 to the luminance data DY, and may, for example, linearly interpolate the luminance data DY to output luminance data DY′. A linear interpolation method according to an exemplary embodiment is used to adjust luminance data DY so as to make the luminance characteristics linear.

FIGS. 4 and 5 are views shown to explain a driving method of a display device according to an exemplary embodiment, and are illustrations of embodiments of the first and second lookup tables.

Referring to FIGS. 4 and 5, the first and second lookup tables have gray level values represented by total luminance data DY of one frame divided into a plurality of ranges Δ1-Δ32 and correction values corresponding to the respective ranges are stored. For example, if total luminance data DY of one frame represents 256 gray levels, each section contains 8 gray levels. That is, the first range Δ1 corresponds to 1-8 gray levels, and the second range Δ2 corresponds to 9-16 gray levels. Although the current embodiment has been described with respect to a case where gray level values represented by total luminance data DY of one frame are divided into 32 ranges, the invention is not limited thereto, and the number of ranges into which the gray level values are divided may be increased or decreased. In the current embodiment, correction values stored in the second lookup table have less magnitude than the correction value of the corresponding range in the first lookup table.

The calculator 416 calculates the correction value of the range corresponding to the difference between total luminance data DYn of an n-th frame and total luminance data DYn-1 of an (n−1)-th frame (total luminance data DYn—total luminance data DYn-1). In some embodiments, if the total luminance data DYn of the n-th frame is greater than the total luminance data DYn-1 of the (n−1)-th frame, the calculator 416 calculates a correction value using the first lookup table. On the other hand, if the total luminance data DYn of the n-th frame is less than the total luminance data DYn-1 of the (n−1)-th frame, the calculator 416 calculates a correction value using the second lookup table. For instance, if the difference between the total luminance data DYn of the n-th frame and the total luminance data DYn-1 of the (n−1)-th frame is “+5”, and the luminance data DY of the n-th frame is 7, the calculator 416 calculates a correction value as being “−5”.

As another example, if the difference between the total luminance data DYn of the n-th frame and the total luminance data DYn-1 of the (n−1)-th frame is “−5”, and the luminance data DY of the n-th frame is 7, the calculator 416 calculates a correction value as being “0”. That is, if the total luminance data DYn of the n-th frame is greater than the total luminance data DYn-1 of the (n−1)-th frame, the calculator 416 generates a correction value of lower magnitude that if the total luminance data DYn of the n-th frame is less than the total luminance data DYn-1 of the (n−1)-th frame. Consequently, it is possible to prevent the luminance characteristics of the luminance data DYn of the n-th frame from being changed by the luminance data DYn-1 of the (n−1)-th frame.

While various embodiments have been described in connection with what is presently considered to be practical, it is to be understood that the invention is not limited to the disclosed embodiments, but, on the contrary, is intended to cover various modifications and equivalent arrangements.

What is claimed is:

1. A display device comprising:
a signal controller configured to generate luminance data in response to a control signal, wherein the signal controller comprises a luminance corrector that corrects the luminance data of a current frame according to a correction value which depends on a difference in luminance data between a previous frame and a current frame; and
a display unit configured to display an image in response to the corrected luminance data.

2. The display device of claim 1, wherein the luminance corrector comprises:
a data converter configured to convert received image data into the luminance data;
a data adder configured to sum the luminance data of frames;
a calculator configured to compare the total luminance data of the previous frame with the total luminance data of the current frame and to calculate a correction value depending on a result of comparison; and
a data processor configured to correct the luminance data by applying the calculated correction value.

3. The display device of claim 2, wherein the calculator is configured to use first and second lookup tables each comprising correction values corresponding to ranges of gray level values represented by total luminance data of each frame, wherein the correction values of the first and second lookup tables are different.

4. The display device of claim 3, wherein a correction value of the second lookup table has a magnitude which is less than a correction value of the corresponding range in the first lookup table.

5. The display device of claim 4, wherein when the total luminance data of the current frame is greater than the total luminance data of the previous frame, the calculator calculates the correction value using the first lookup table.

6. The display device of claim 4, wherein when the total luminance data of the current frame is less than the total luminance data of the previous frame, the calculator calculates the correction value using the second lookup table.

7. A method of driving a display device, the method comprising:
summing luminance data of a previous frame;
summing luminance data of a current frame;
comparing the summed luminance data of the previous frame with the summed luminance data of the current frame;
calculating a correction value depending on a result of the comparison; and
correcting the luminance data of the current frame based on the correction value.

8. The method of claim 7, wherein, correcting of the luminance data comprises using first and second lookup tables each comprising correction values corresponding to ranges of gray level values represented by total luminance data of each frame, wherein the correction values of the first and second lookup tables are different.

9. The method of claim 8, wherein a correction value of the second lookup table has a magnitude which is less than a correction value of the corresponding range in the first lookup table.

10. The method of claim 9, wherein, when the total luminance data of the current frame is greater than the total luminance data of the previous frame, the correction value is calculated using the first lookup table.

11. The method of claim 9, wherein, when the total luminance data of the current frame is less than the total luminance data of the previous frame, the correction value is calculated using the second lookup table.
